(19) United States
(12) Patent Application Publication
(10) Pub. No.: US 2018/0276896 A1
(43) Pub. Date: Sep. 27, 2018

(54) SYSTEM AND METHOD FOR AUGMENTED REALITY ANNOTATIONS

(71) Applicant: PCMS Holdings, Inc., Wilmington, DE (US)

(72) Inventor: Raimo J. Launonen, Nummela (FI)

(21) Appl. No.: 15/524,365

(22) PCT Filed: Oct. 20, 2015
(86) PCT No.: PCT/US2015/056360

§ 371 Date: May 4, 2017

Related U.S. Application Data
(60) Provisional application No. 62/076,869, filed on Nov. 7, 2014.

(51) Int. Cl. G06T 19/00; G06K 9/00; G06K 9/46

(52) U.S. Cl. CPC G06T 19/006; G06K 9/00442; G02B 27/0172; G06K 9/00979; G06T 2219/004; G06K 9/4633

(57) ABSTRACT

The present disclosure relates to systems and procedures to permit user-generated content, such as underlining, highlighting, and comments, to be shared to printed media via an augmented reality (AR) system, such as a head mounted display, tablet, mobile phone, or projector, without the need to have an electronic text-version of the printed media. In an exemplary method, an augmented reality user device obtains an image of a printed page of text, and image recognition techniques are used to identify the page. An annotation associated with the identified page is retrieved, and the augmented reality device displays the annotation as an overlay on the identified page.

### CROSS-REFERENCE TO RELATED APPLICATIONS

This application claims priority to and the benefit under 35 U.S.C. § 119(e) of U.S. Provisional Patent Application Ser. No. 62/076,869, filed Nov. 7, 2014 and entitled “System and Method for Augmented Reality Annotations,” the full contents of which are hereby incorporated herein by reference.

### TECHNICAL FIELD

This present disclosure relates to information sharing among users with the use of augmented reality (AR) systems, such as a head mounted display, tablet, mobile phone, or projector.

### BACKGROUND

Readers often annotate and share printed materials. The annotations can include underlining, highlighting, adding notes, and a variety of other markings. However, these annotations involve making marks on the printed material, and sharing the annotations requires the user either to share the printed material with a third party or to make a copy of the annotated material to share with a third party. In many cases, marking on the printed material is not desired or is prohibited, as is the case with antique books and library books. Readers may also wish to share their annotations, or other user-generated-content, with third parties, including classmates, book club members, enthusiasts, family members, etc. Augmented reality can assist in sharing the UGC.

Augmented reality typically involves overlaying digital content into a user's view of the real world. In some instances, AR combines real and virtual elements, is interactive in real time and may be rendered in 3D. However, AR can also occur not in real time (editing photographs after the fact), and can also not be interactive or in 3D (adding distance lines in live broadcast of sporting events). Several common types of AR display devices include computers, cameras, mobile phones, tablets, smart glasses, head-mounted displays (HMD), projector based systems, and public screens.

Common examples and applications of AR include (1) browsing point-of-interest information augmented in live video view on a mobile phone or tablet as done by Layar, junaio, Wikitude, and TagWhat; (2) brand advertising augmented on printed advertisements and packages as done by Aurasma, Blippar, and Daqri; and (3) games, entertainment, industrial production, real estate, medical, and military.

Other similar uses include eLearning applications where notes can be shared with other students. However, those systems cover only electronic books and the functionalities do not cover printed products or augmented reality features.

### SUMMARY

The disclosure describes an Augmented Reality (AR) system for sharing user-generated content (UGC) with regards to printed media. The present disclosure provides systems and methods to create UGC linked to printed media that is visible with AR visualization equipment. The methods do not require actual markings on the printed media or an electronic text-version of the page or book. The UGC can be shared with other users, including students, classmates, book club members, enthusiasts, friends, and family members. The system can show a selected combination of the highlighted parts of one or several users, such as portions of the book that are highlighted by most of other students in the class or by the instructor. The UGC created with printed material may also be viewed in combination with electronic material, electronic books, and audio books.

In an exemplary embodiment, an AR visualization device recognizes a page of printed text or other media, the AR device detects and records creation of UGC, and the UGC is correlated to a precise location on the page. Additionally, the AR visualization device can recognize a page of printed text or other media, retrieve UGC correlated to the page of printed media and display the UGC on the page of printed text.

In some embodiments, the image recognition used to identify a page is conducted without comparing the text of the printed page with the text of a reference page. As a result, there is no need to store an electronic library of text, which could pose logistical challenges as well as generating potential copyright issues.

In embodiments disclosed herein, recognizing a page does not require text recognition or actual marks to be made on the printed material. Embodiments disclosed herein are compatible with old and other printed books that do not have electronic versions at all or whose electronic versions are not readily available. These embodiments also allow the virtual highlighting and underlining of rare and/or valuable books without risking damage to the books.

In embodiments disclosed herein, the AR visualization device operates a camera of an augmented reality device to obtain an image of a printed page or text and using image recognition to retrieve an annotation associated with the page. In some embodiments, the camera is a front-facing camera of the augmented reality glasses.

The image recognition may occur locally at the AR visualization device, or at a network service receiving an image of the page taken by the AR visualization device.

In embodiments wherein a plurality of annotations corresponding to a page of printed text are received from a plurality of users, a subset of the annotations may be displayed. The subset may be selected from annotations from a particular user, a group of users, or annotations correlated to a particular location on the page.

### BRIEF DESCRIPTION OF THE DRAWINGS

FIG. 1 is a flow chart of an exemplary method that may be used in some embodiments.

FIG. 2 is a flow chart of an exemplary method that may be used in some embodiments.

FIG. 3A is a flow chart of an exemplary method that may be used in some embodiments.

FIG. 3B depicts visualization of UGC on a printed page that may be used in some embodiments.

FIG. 4A is a flow chart of an exemplary method that may be used in some embodiments.

FIGS. 4B and 4C depict views of a database that may be used in some embodiments.

FIG. 5 depicts a view of a database that may be used in some embodiments.

FIG. 6 is a schematic block diagram illustrating the components of an exemplary augmented reality device implemented as a wireless transmit/receive unit.

FIG. 7 is a schematic block diagram illustrating the components of an exemplary computer server that can be used in some embodiments for the sharing of annotations and/or page identification.

### DETAILED DESCRIPTION

This disclosure describes an AR system that permits users to share user-generated content (UGC) linked to printed media. The techniques disclosed herein provide a means for recognized page images, capturing the creation of UGC, retrieval of the UGC, and display of the UGC onto printed media.

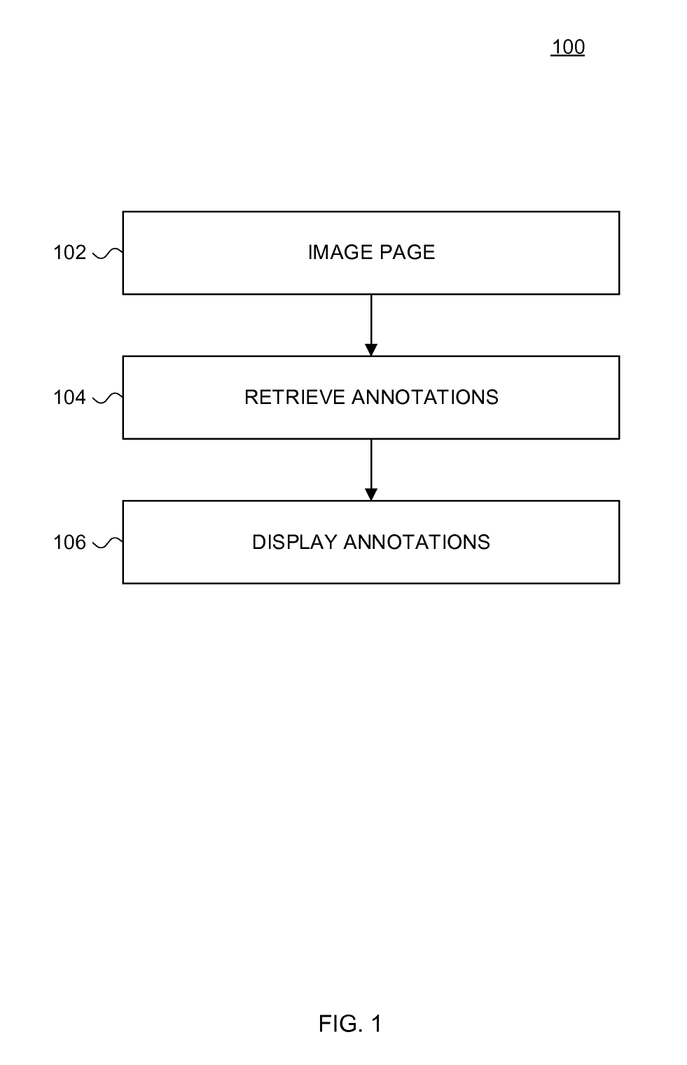

FIG. 1 displays an exemplary embodiment. In particular, FIG. 1 depicts the method 100. The method 100 details the capturing and displaying UGC on printed material. In an exemplary embodiment, a page of printed media is recognized at step 102. Page recognition is accomplished by comparing an image of the page to other page images stored in a database. This means that the page is in a set of pages. The page image of the page does not have to be identical with the page image in the database but the system is able to recognize that the new page image is an image of one of the pages. “Page recognition” and “recognize page” does not require that the textual or other content of the page is recognized e.g. using OCR or electronic textual content e.g. pdf. At step 104, new UGC is generated and shared and existing UGC is retrieved from a database. At step 106, an AR system is used to display the UGC on the page of the printed media.

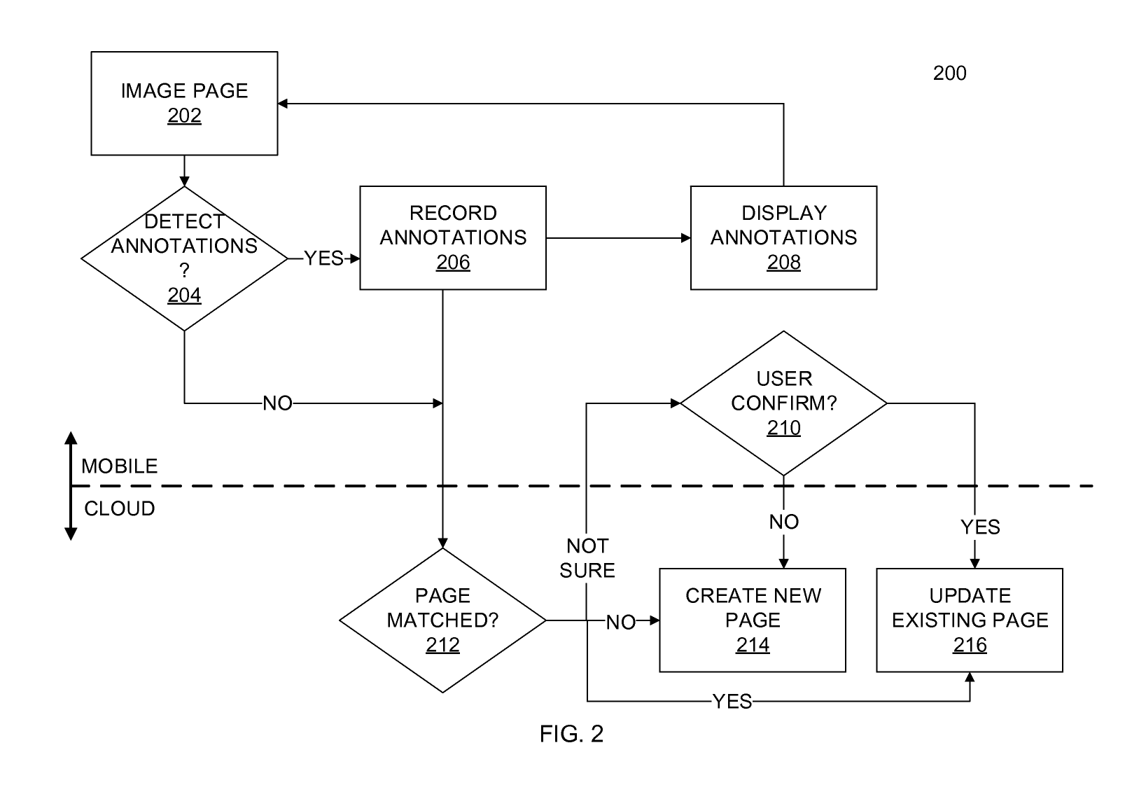

FIG. 2 displays an exemplary embodiment. In particular, FIG. 2 depicts a method 200 for creating UGC. The method 200 comprises an image page step at 202, a check for detected annotations at step 204, recording annotations at step 206, displaying annotations at step 208, a user confirmation check at step 210, a page matched check at step 212, creation of a new page at step 214, and updating an existing page at step 216. FIG. 2 depicts steps performed on a mobile device, such as an AR system, and steps performed in the cloud, such as a remote server in communication with the AR system.

At step 202, an AR system, comprising an image capture device such as a camera, is used to recognize a page. The AR system takes a picture of the page. A computing unit is used and an image, fingerprint, hash, or other extracted features of the page image are stored for page recognition needs. The user can select user group and/or book group to limit the number of book pages searched so that the page recognition is faster and more reliable.

Page recognition can be employed using technology described in U.S. Pat. No. 8,151,187, among other alternatives. For example, page recognition may include generating a signature value or a set of signature values of the image. The signature values serve as an identifier of the text page. Determining a signature value may comprise determining positions of a word in a text page and determining positions of multiple second words in the text page relative to the position of the first word in the text page. The signature value represents the relative position of the second word positions to the first word position.

At step 204, a check for generated annotations is made. Using a pointer, stylus, finger, etc. the user is able to select specific portions of the document page, such as text to underline or highlight. Other types of UGC can be inserted, such as notes, internet links, audio, or video. If annotations are detected, they are recorded at step 206 and displayed at step 208. The position information parameters (e.g. visual/textual representation, x-y-location, width/length, color) of the UGC related to the page is stored and connected to the user, user group, and to the page of the book. The imaged page is matched at step 212. The page identification (fingerprint, hash etc.) and the UGC (e.g. highlighting, underlining, notes, etc.) on the page are linked.

Additional methods to create UGC in exemplary embodiments include: handwriting and drawing with a writing instrument, stylus, or finger gestures, laser pointer, keyboard, tablet, smartphone, spoken input, speech recognition, and computer interactions such as file drag and drop, cut and paste, etc.

In exemplary embodiments, a stylus is used to create UGC. The stylus may include some or all of the following features:
A pen type of stylus having another type of indicator for marker on/off e.g. led lamp.
A pen type of stylus without any indicator for marker on/off. The marking is detected based on special movements of the stylus: e.g. the movement of the tip is parallel to a line on page.
A user's fingertip.

A user can draw and write using a stylus or using a finger so that the movements of the pointing object (e.g. stylus) can be large or the most appropriate for the user during the input phase of textual handwriting. The stored and visualized annotation can be zoomed to smaller size in order to fit on the intended actual place on page. In some embodiments, a user's handwriting can be recognized using text recognition or OCR software so that only text will be stored instead of image of the handwriting. During the visualization process the annotations can be zoomed in or out to the most appropriate size for the user.

Various capture and image recognition systems can be used with embodiments disclosed herein. A similar capturing example is the Anoto technology that provides a means to capture the interaction of a digital pen with normal paper. (Dachselt, Raimund, and S. Al-Saiegh. “Interacting with printed books using digital pens and smart mobile projection.” Proc. of the Workshop on Mobile and Personal Projection (MP2)@ ACM CHI. Vol. 2011. 2011.) A small dot pattern is printed on each sheet of paper. The infrared camera integrated into the tip of the pen sees this pattern and processes it using onboard image recognition. Since the pattern is unique, the absolute position of the pen on the paper can be tracked exactly. The book is printed on a special Anoto paper.

Some example image recognition technologies that can be employed to effect page recognition include the following, among others:
Frieder, Ophir and Abdur Chowdhury. System for similar document detection. U.S. Pat. No. 7,660,819, filed Jul. 31, 2000.
Likforman-Sulem, Laurence, Anadid Hanimyan, and Claudie Faure. “A Hough based algorithm for extracting text lines in handwritten documents.” Document Analysis and Recognition, 1995., Proceedings of the Third International Conference on. Vol. 2. IEEE, 1995.
Okun, Oleg, Matti Pietikäinen, and Jaakko Sauvola. “Document skew estimation without angle range restriction.” International Journal on Document Analysis and Recognition 2.2-3 (1999): 132-144.
Pugh, William and Monika Henzinger. Detecting duplicate and near-duplicate files. U.S. Pat. No. 6,658,423, filed Jan. 24, 2001.
Shijian Lu; Linlin Li; Tan, C. L., “Document Image Retrieval through Word Shape Coding,” in Pattern Analysis and Machine Intelligence, IEEE Transactions on, vol. 30, no. 11, pp. 1913-1918, November 2008.
Singh, Chandan, Nitin Bhatia, and Amandeep Kaur. “Hough transform based fast skew detection and accurate skew correction methods.” Pattern Recognition 41.12 (2008): 3528-3546.
Srihari, Sargur N., and Venugopal Govindaraju. “Analysis of textual images using the Hough transform.” Machine Vision and Applications 2.3 (1989): 141-153.
Tsai, S. S.; Huizhong Chen; Chen, D.; Parameswaran, V.; Grzeszczuk, R.; Girod, B., “Visual Text Features for Image Matching,” in Multimedia (ISM), 2012 IEEE International Symposium on, vol., no., pp. 408-412, 10-12 Dec. 2012.

In addition to virtual UGC, actual content can be captured and shared. A user can start with a clean book page and create markings and annotations with a real pen/ink which the AR system will capture and save this UGC to be shared with other users having their own issue of the same book. The AR system will capture the page image of the page before and after the real UGC so that the page will be recognized also as clean but also as marked with user key strokes. In some embodiments, the AR system captures the clean page image before the UGC has been entered, the system could separate the UCG and printed text after the UGC has been entered by various methods, such as the method described in US 2003/0004991 “Correlating handwritten annotations to a document”.

In exemplary embodiments, the AR system can be used with both printed books electronic material. A user inserts links to electronic material as annotations. The links can be inserted in both ways: from printed media to electronic media and from electronic media to printed media. For example, the stored UGC content on printed media (and second option: in electronic book) can have URL-type of addresses so that these links can be copied to electronic documents (and the second option: to printed book). Then users can have access to both materials, printed and electronic, and also access to UGC related to both sources.

At step 212, a cloud service determines whether a page is matched. Matching an image to a page may be limited by narrowing a search utilizing different criteria, such as a select user, user group, or book group. If a cloud service is not sure the image matches a page, mobile device may present a confirmation check at step 210. The confirmation check may include displaying the suspected match to the user on the mobile device and receiving an input from a user if the page is a match.

If the page is matched, either through user confirmation (step 210) or via the cloud service (step 212), the database for the existing page is updated at step 216. Updating the database may include storing the image or an alternative representation of the image. If the page is not matched, either through user confirmation (step 210) or via the cloud service (step 212), the database is updated by creating a new page. The database updates include linking the detected UGC to the imaged pages. The information saved in the database may include a user identifier, the perceptual hashes, and the links between the UGC and the pages.

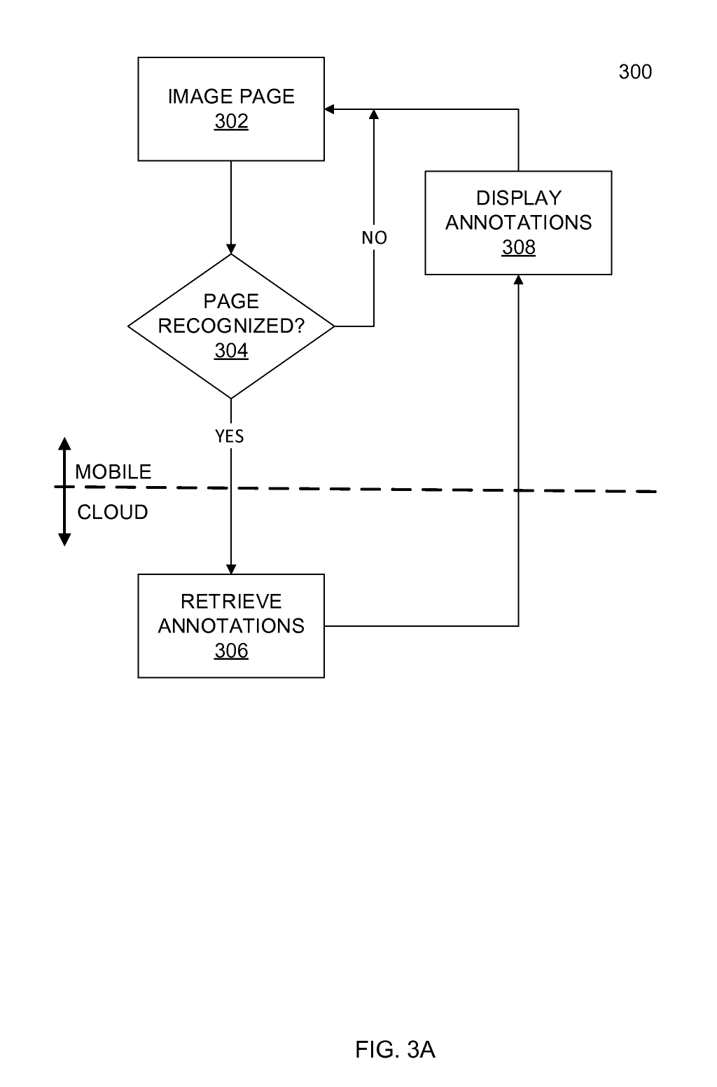

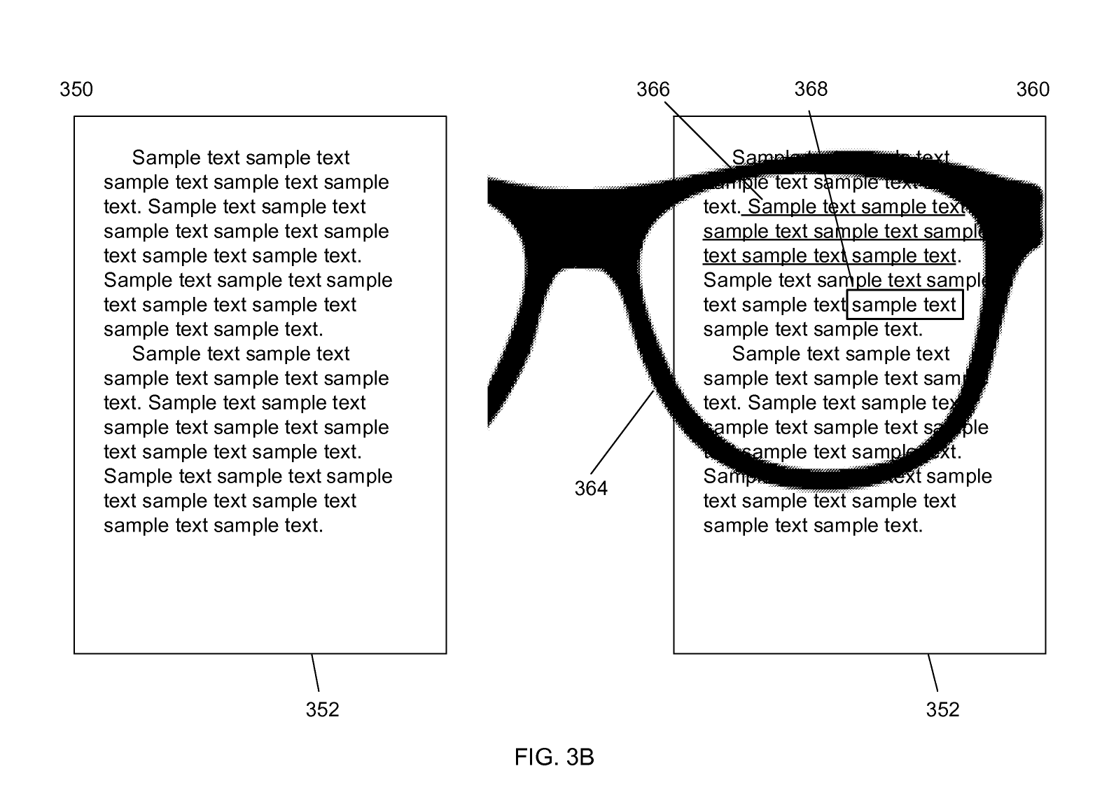

FIG. 3A displays an exemplary embodiment. In particular, FIG. 3A depicts a method 300 to visualize the UGC on printed media. The method 300 comprises imaging a page at step 302, a page recognition check at step 304, the retrieval of annotations at step 306, and displaying the annotations at step 308. Similar to FIG. 2, FIG. 3 depicts actions and steps taken on a mobile device, such as an AR system, and steps taken in the cloud, such as a remote server in communication with the AR system.

At step 302, an image of a page is taken. The imaging process of step 302 may be accomplished similarly to the imaging process of step 202 in FIG. 2. At step 304, a check is performed to determine whether the image of the page is recognized. The check may be performed by comparing a perceptual hash or signature value of the imaged page with a set of perceptual hashes or signature values stored as reference. The set of perceptual hashes or signature values may be narrowed by associating a user, a user group, or book group with the image, as described in greater detail below. In accordance with an embodiment, the page recognition check comprises the mobile device, or AR system, sending an image to a remote server. The remote server generates a signature or hash associated with the received image, and compares the generated signature or hash with reference signatures or hashes. If a page is not recognized, the AR system may take another image of the page. If the page is, or likely is, identified, annotations are retrieved at step 306.

At step 306, annotations associated with the recognized page are retrieved. The retrieved annotations comprise the data in the UGC and a location of the UGC. At step 308, the AR system displays the retrieved annotations on the page. Displaying the annotations may be accomplished by overlaying the annotations on a live video image or on a printed page using a projector, or via any other means as known by those with skill in the relevant art.

In order to see the UGC later, the stored features and stored user generated content parameters are used to discover the correct page from page feature database and to show the UGC: bookmarks, highlights and/or notes/comments/links for that page on the correct position on the page using AR.

Additionally, UGC can be displayed with various AR systems including, but not limited to, using a head mounted display, tablet or mobile phone as a magic see-through mirror/window. A projector to augment the UGC on the page of printed media can also be used. With see-through type of AR equipment it is easier to read the printed text than using live-video type of display.

To display UGC with an AR system correctly aligned with the real world generally requires tracking of the camera position relative to the camera view. Various tracking methods can be employed, including marker based methods (e.g. ARToolKit), 2D image based methods (e.g. Qualcomm, Aurasma, Blippar), 3D feature based methods (e.g. Metaio, Total Immersion), sensor based (e.g. using gyro-compass, accelerometer) and hybrid methods. Specialized tracking methods can also be employed, including face tracking, hand/finger tracking etc.

In some embodiments, visualization of UGC snaps in correct size, orientation, and location, e.g. line or paragraph on page because several page images can represent same page and the zoom factor of these images can also be different. A cloud service can be used to match these page images to each other and any of the originals can be used in order to find the match page during visualization and content creation phases.

The AR visualization process can display UGC on the top of the text or on the white areas of the printed book or outside the page area. If the UGC is disturbing the visibility of the actual page, the user can switch the UGC on/off using different interaction methods.

FIG. 3B depicts visualization of UGC on a printed page that may be used in some embodiments. FIG. 3B shows a first view 350 on the left and a second view 360 on the right. The example method 300, discussed with FIG. 3A, may be used to display the UGC on the printed pages. In FIG. 3B, the view 350 represents a user's view of a page 352 of when viewed without any augmented reality annotation. The page 352 is a page of sample text. The view 360 represents a user's view of the sample page 352 (the same page as in view 350) through an augmented reality headset in an exemplary embodiment. In the view 350, AR system 364 is displaying a first annotation 366 and a second annotation 368.

Using the method 300, described in conjunction with FIG. 3A, with the views 350 and 360 of FIG. 3B, an image is taken of the page 352 (step 302). The image may be taken with a camera located in the AR system 364. In some embodiments, the camera is a front-facing camera glasses of an AR system. The page is recognized (step 304) and annotations associated with the page are retrieved (step 306). The retrieval of the annotations includes the type of annotation, the content of the annotation, and a position on the page the annotation is to be displayed. The AR system displays (step 308) the first annotation 366 and the second annotation 368 on the page. The first annotation 366 is underlining of the second sentence on page 352. The second annotation 368, depicted by a box, represents a portion of sample text to be highlighted. The portion of text to be highlighted is the last two words of the seventh line on the page 352. The two sample annotations are displayed by the AR system 364 utilizing the data associated with the UGC.

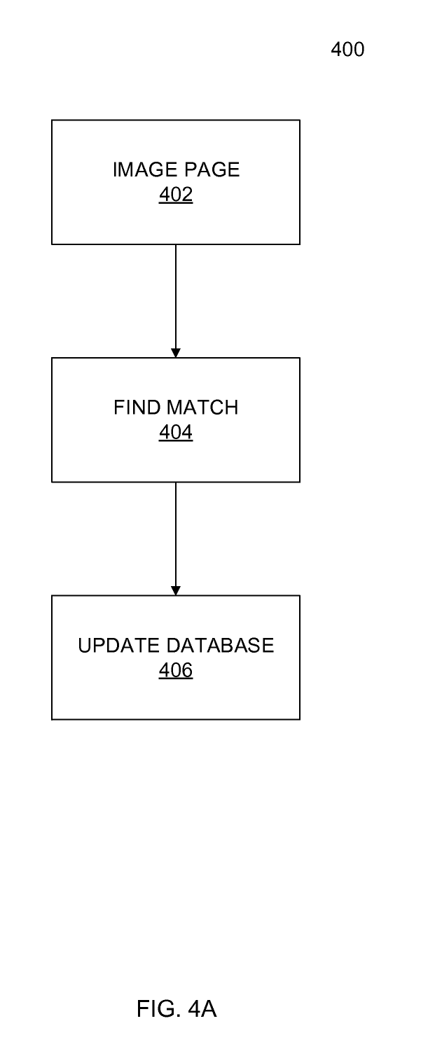

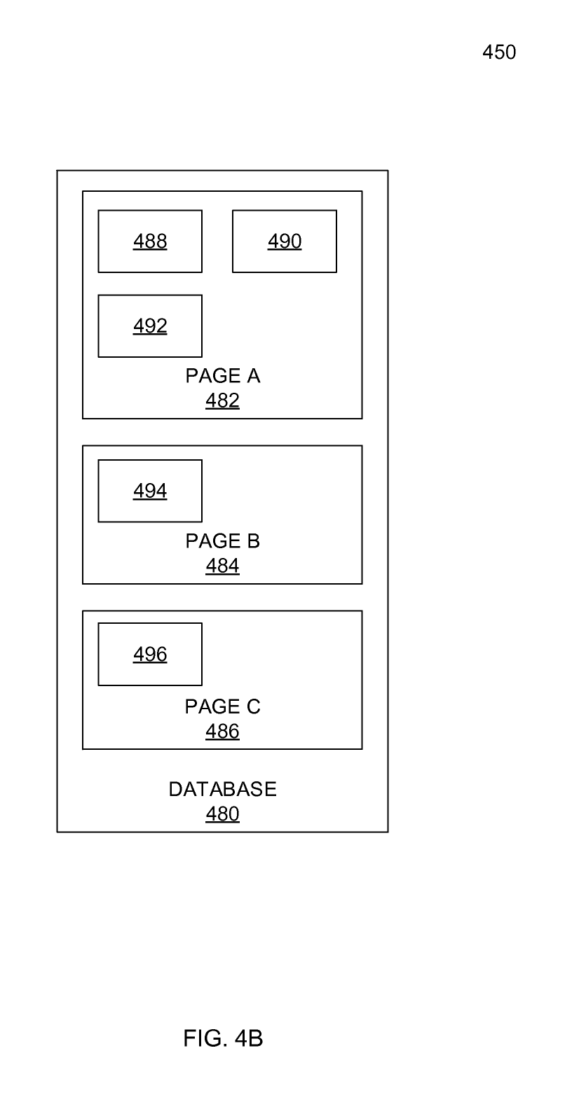

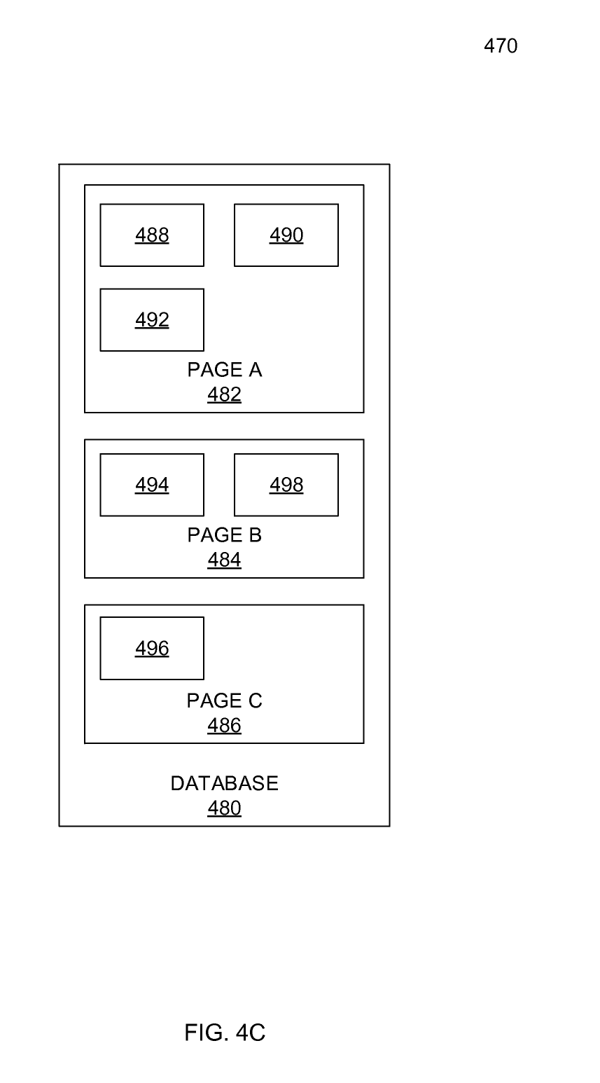

FIG. 4A shows an exemplary embodiment. In particular FIG. 4 shows a method 400 to recognize a page from a set of pages and how to update images to the database. The method 400 images the page at step 402, finds a match at step 404, and updates a database at step 406. The method 400 may be used in conjunction with FIGS. 4B and 4C.

FIGS. 4B and 4C depict views of a database that may be used in some embodiments. In particular, FIG. 4B depicts a first view of a database 450. The first view of the database 450 depicts the database 480 at an initial state. The database 480 includes three sections. The first section 482 includes records of images associated with Page A, the records of images 488, 490, and 492. The second section 484 includes records of images associated with Page B, the record of image 494. The third section 486 includes records of images associated with Page C, the record of image 496. The records of images 488-496 are images or representations of images of various pages. Throughout this application, the phrase “image of the page” may include an image of the page or an alternate representation of the page. The pages may be alternately represented by a signature, a hash, or any similar representation of a page.

The method 400 of FIG. 4A may be used to update the database 480 of FIG. 4B. In this method, a new page is imaged, corresponding to step 402. The image of the new page may be converted to an alternate representation. The new page image, or alternate representation of the new page image, is compared against images or representations of images stored in a database to find a match, corresponding to step 404. The database is updated with the record of the new image or representation of the image after a database update, corresponding to step 406.

The matching process (step 404) may involve either finding the closest match to a single image of each of the pages, or comparing the new image to a compilation of the images associated with each page.

The page recognition reliability is enhanced because several page images or representations can represent same page. As shown in FIG. 4B, in view 450, “Page A” has three different page images (images 488, 490, and 492), and “Page B” and “Page C” each have one, images 494 and 496 respectively.

In an example process, a new page is imaged per step 402, generating a new page image 498. In the matching process of step 404, a new page image 498 is generated and is recognized to be an image of “Page B”. In the second view of the database 470 of FIG. 4C, the new page image 498 is added to the database 480 to represent “Page B” and the portion of the database storing images associated with Page B 484 will now have two page images, 494 and 498. This is how user activity will enhance the system reliability: more candidates for one page is better than only one. In some embodiments, page features and perceptual hashes of page images can be used instead of or in addition to page images.

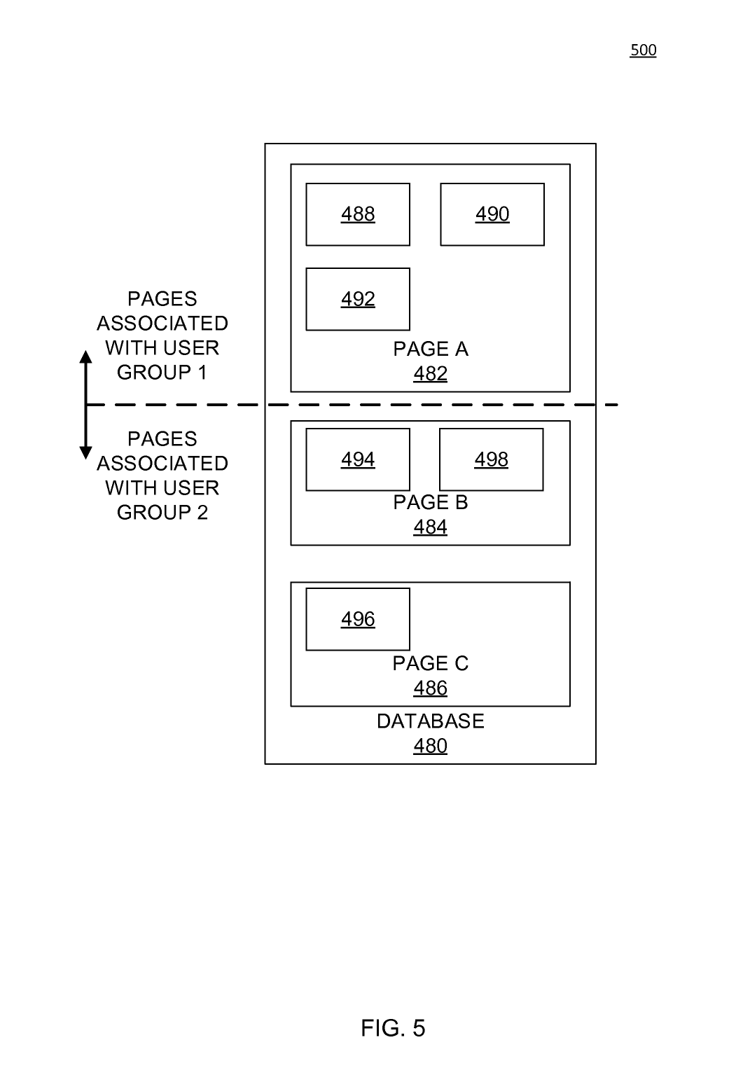

FIG. 5 depicts a view of a database that may be used in some embodiments. In particular, FIG. 5 shows a method of searching page images based on user groups. FIG. 5 depicts a view of a database 500. The view of the database 500 includes database 480 of FIG. 4C. However, the database 480 is segmented into pages associated with User Group 1 (Page A), and pages associated with User Group 2 (Pages B and C). The page search may be from whole or from districted database of pages, e.g. from the pages of books of certain topic or use group like school class books. A user can select a user group and/or book group, and this information is used to limit the number of book pages being searched so that the page recognition can be faster and more reliable. In addition, the user group can be used for social media features: to share user generated content within the user group.

The matching process (step 402 of the process 400) may further include limiting a search for matches of a new image to a limited portion of stored representations. As shown in FIG. 5, portions of the database include pages associated with different user groups. In this example a user is associated with User Group 2, which is restricted from accessing pages associated with User Group 1. In the matching process of step 402 of the process 400, a new image of a page is generated by a user associated with User Group 2. The new image of the page is not checked against the database of images associated with Page A 482 because the new image of the page is associated with a User Group that is restricted from accessing that subset of pages. The new image of the page is checked against the database of images associated with Page B and C (484 and 486, respectively) and is matched to Page B.

In exemplary embodiments, various methods can be used to select which UGC to display via the AR system. Specialized AR content authoring software such as Metaio Creator and AR-Media enable placing the UGC relative to the chosen marker, image etc. Contents for POI browser applications such as Layar and Wikitude can be defined by indicating the geo location coordinates of the various contents involved, and the contents can also be automatically extracted from map based services.

In exemplary embodiments, combinations of the UGC of different users can be augmented/visualized and browsed using different visual or audio cues. Example cues include different colors per user, sound, text, or other ways to distinguish users.

Users can also rank the UGC of other users e.g. of user group so that the best ranked content will have the highest priority in visualization. In these embodiments, the best or most popular UGC will be shown or is shown in a different color than the second best. A subset of annotations to be displayed may be from a particular user, a group of users, or may be annotations correlated to a particular location on the page.

In exemplary embodiments, the AR system can automatically, without user rankings, show only or in special priority color those user markings which are the most popular within the users. A user can also select different display options, such as an option to show, e.g., the UGC of the teacher, a friend/colleague, UCG ranked as best, the most marked, or to show only one of those (e.g. the best) or several different types of UCG using different colors.

The UGC can be shared with other users, and the system can, for example, show a combination of the underlining and highlighted parts of several users, such as parts highlighted by most of the users e.g. most of other students or highlighted by the teacher(s), to show the most important parts of the book and page. To show different levels of importance, different colors or visual effects like blinking can be used.

Some exemplary embodiments allow also the combination of content from several end users in a single AR view, e.g. sharing geo-located social media messages with POI browsers. In exemplary embodiments, the AR system comprises both a mobile terminal and cloud data service. The functionalities of the AR system can be divided between the mobile terminal and the cloud data service in different ways based on needed computing power and available storage capacity. Fast and less demanding functions can be performed in mobile terminal and the more demanding parts can be done in a powerful cloud environment.

In one exemplary embodiment, an AR system performs some or all of the following steps. A camera takes a picture of printed media (e.g. book) and performs a page recognition process. The AR system detects UGC on the page. The AR system stores and shares UGC with other users. The AR system displays the user's own UGC and other shared UGC as an overlay on the page or outside the page area. In some embodiments, the UGC annotations displayed by the AR system are aligned with specific lines of text on the annotated page. The annotations may be transparent such that, the user can read the text of the physical page through the highlighting. Stored information on the annotations can be used to indicate specific portions of a page that have been selected for annotation and/or highlighting, and those specific portions can be highlighted or underlined as appropriate by the reader's AR system.

The AR system stores an additional image of the page to enhance page recognition. The AR system manages user groups and book page groups. The AR system shares UGC of several users using automatic and manual ranking. The AR system connects to the features of social media, learning, and training services.

In exemplary embodiments, an electronic text version e.g. txt or pdf file of the printed book is not needed because the page image features can be used to discover to page. It is not necessary for a user to enter the book title because the page itself can be recognized. In some embodiments, page recognition is enhanced when several page images from the same page are used to calculate several parallel representatives (e.g. but not limited to page images, feature based perceptual hashes) for the page (see FIGS. 4A and 4B).

When a user creates augmented reality annotations, an AR overlay display can be used to visualize the annotations for the creating user. AR overlay displays are used to visualize the UGC during reading afterwards both for the first user who created the content and for other users (community). The user can use see-through-video-glasses as augmented reality visualization equipment, and the UGC will be displayed as an overlay on the printed page, either as an overly on the text (e.g., underlining or highlighting) or in the margin (e.g. marginal notes). Display of the UGC as an overlay on the text page itself enhances the readability of the UGC, particularly where the UGC appears as a transparent overlay seen through, for example, AR glasses. Textual annotations that can be read when projected within the blank margin of a book might otherwise be difficult to read if they were projected at an arbitrary location in the user's field of vision.

Embodiments disclosed herein further enable sharing and visualization of UGC among a group of users. Real time collaboration features such as highlighting and note chat share content within a user group. Non-real-time users can see the shared chat discussion history of other users e.g. within the user group. Textual or audio chat can be conducted with shared UGC e.g. underlinings before a mutual meeting or before an exam.

Page recognition is enhanced in some embodiments by limiting the books being searched (and thus limiting the size of the feature database being searched) to selected books of a school class or topic area. In some embodiments, the book itself is identified by user input, and image recognition is used only to identify particular pages within the book. Page recognition can be enhanced in some embodiments by considering recently-identified pages. For example, once a page is identified, a subsequent page viewed by the user is more likely to be another page in the same book (as compared to an arbitrary page of some other book), and is even more likely to be, for example, the subsequent page in the same book.

Page recognition can also be enhanced by limiting access based on user-group-limited sharing. The relevant user group can be user generated community in social media e.g. school class, book club, enthusiasts, interest group, etc.

If the page is not found, page recognition can be enhanced with user input. For example, the system can show a page image or several from the database and ask user “Is this the page?” If the page is not found, the mobile system can upload the page images to cloud server, and more sophisticated image match algorithms can be utilized.

In exemplary embodiments, various methods are used to create, detect, and depict UGC. These methods include:
A 3D-sensor and system to recognize pointing finger without marker.
A camera based recognition of the pointing stylus using marker or without marker.
A projector to show UGC overlays on printed books without the use of a head mounted display.
A point or line type of laser can be used as a computing unit controller projector to show/augment the user generated content, e.g. underlining, on the page of the printed book.
A separate device e.g. tablet, PC, mobile phone or dedicated gadget can be used to visualize UGC, e.g. annotations. Such devices can also use a text-to-speech system to convey the annotations audibly.

In exemplary embodiments, a still image instead of a video image is used in AR visualization when displaying the printed media and the UGC on a tablet or other mobile device.

In exemplary embodiments, UGC content such as highlighting, underlining and annotations are created on a computer display, and this UGC can be mapped to captured image features of the displayed page.

In exemplary embodiments, the UGC (e.g. underlining, highlighting and annotations) can displayed in electronic documents and in electronic books (e-books). If the appearance of an electronic document/e-book is not the same as the appearance of the same copy of a printed book, then content recognition type of page recognition (e.g. OCR) can be used in order to find the exact location for the user generated content on electronic book. A user can add UGC using a printed document or electronic document and user can see mentioned added UGC augmented on printed document and on electronic document.

In exemplary embodiments, the AR system connects to real-time text, audio, or video chat and with social media systems.

In exemplary embodiments, the electronic document is an audiobook. The UGC can be communicated to the user via audio and text-to-speech technology. The user also creates UGC by speaking. The UGC is stored as an audio clip or a text annotation using speech recognition.

In exemplary embodiments, a user is only able to see pages that are associated with UGC. A user can browse and search UGC, using search terms and various filters to “show next page with UGC,” “show next page with a specific type of UGC (underline, highlight, etc.).” Additional navigation abilities include searching by page number, either by handwriting with stylus, finger gesture, camera unit, or speaking a number.

Note that various hardware elements of one or more of the described embodiments are referred to as “systems” that carry out (i.e., perform, execute, and the like) various functions that are described herein in connection with the respective systems. As used herein, a system may include hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described system may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

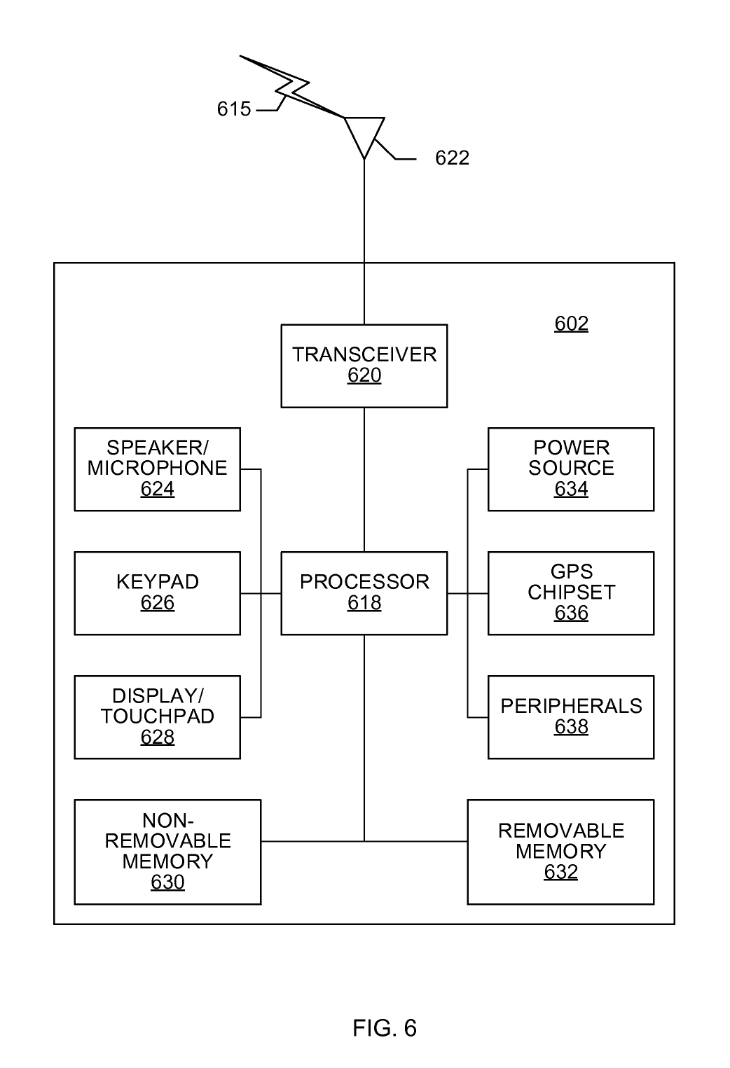

In some embodiments, the systems and methods described herein may be implemented in a wireless transmit receive unit (WTRU), such as WTRU 602 illustrated in FIG. 6. For example, the AR visualization system may be implemented using one or more software modules on a WTRU.

As shown in FIG. 6, the WTRU 602 may include a processor 618, a transceiver 620, a transmit/receive element 622, audio transducers 624 (preferably including at least two microphones and at least two speakers, which may be earphones), a keypad 626, a display/touchpad 628, a non-removable memory 630, a removable memory 632, a power source 634, a global positioning system (GPS) chipset 636, and other peripherals 638. It will be appreciated that the WTRU 602 may include any sub-combination of the foregoing elements while remaining consistent with an embodiment. The WTRU may communicate with nodes such as, but not limited to, base transceiver station (BTS), a Node-B, a site controller, an access point (AP), a home node-B, an evolved home node-B (eNodeB), a home evolved node-B (HeNB), a home evolved node-B gateway, and proxy nodes, among others.

The processor 618 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 618 may perform signal coding, data processing, power control, input/output processing, and/or any other functionality that enables the WTRU 602 to operate in a wireless environment. The processor 618 may be coupled to the transceiver 620, which may be coupled to the transmit/receive element 622. While FIG. 6 depicts the processor 618 and the transceiver 620 as separate components, it will be appreciated that the processor 618 and the transceiver 620 may be integrated together in an electronic package or chip.

The transmit/receive element 622 may be configured to transmit signals to, or receive signals from, a node over the air interface 615. For example, in one embodiment, the transmit/receive element 622 may be an antenna configured to transmit and/or receive RF signals. In another embodiment, the transmit/receive element 622 may be an emitter/detector configured to transmit and/or receive IR, UV, or visible light signals, as examples. In yet another embodiment, the transmit/receive element 622 may be configured to transmit and receive both RF and light signals. It will be appreciated that the transmit/receive element 622 may be configured to transmit and/or receive any combination of wireless signals.

In addition, although the transmit/receive element 622 is depicted in FIG. 6 as a single element, the WTRU 602 may include any number of transmit/receive elements 622. More specifically, the WTRU 602 may employ MIMO technology. Thus, in one embodiment, the WTRU 602 may include two or more transmit/receive elements 622 (e.g., multiple antennas) for transmitting and receiving wireless signals over the air interface 615.

The transceiver 620 may be configured to modulate the signals that are to be transmitted by the transmit/receive element 622 and to demodulate the signals that are received by the transmit/receive element 622. As noted above, the WTRU 702 may have multi-mode capabilities. Thus, the transceiver 620 may include multiple transceivers for enabling the WTRU 602 to communicate via multiple RATs, such as UTRA and IEEE 802.11, as examples.

The processor 618 of the WTRU 602 may be coupled to, and may receive user input data from, the audio transducers 624, the keypad 626, and/or the display/touchpad 628 (e.g., a liquid crystal display (LCD) display unit or organic light-emitting diode (OLED) display unit). The processor 618 may also output user data to the speaker/microphone 624, the keypad 626, and/or the display/touchpad 628. In addition, the processor 618 may access information from, and store data in, any type of suitable memory, such as the non-removable memory 630 and/or the removable memory 632. The non-removable memory 630 may include random-access memory (RAM), read-only memory (ROM), a hard disk, or any other type of memory storage device. The removable memory 632 may include a subscriber identity module (SIM) card, a memory stick, a secure digital (SD) memory card, and the like. In other embodiments, the processor 618 may access information from, and store data in, memory that is not physically located on the WTRU 602, such as on a server or a home computer (not shown).

The processor 618 may receive power from the power source 634, and may be configured to distribute and/or control the power to the other components in the WTRU 602. The power source 634 may be any suitable device for powering the WTRU 602. As examples, the power source 634 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 618 may also be coupled to the GPS chipset 636, which may be configured to provide location information (e.g., longitude and latitude) regarding the current location of the WTRU 602. In addition to, or in lieu of, the information from the GPS chipset 636, the WTRU 602 may receive location information over the air interface 615 from a base station and/or determine its location based on the timing of the signals being received from two or more nearby base stations. It will be appreciated that the WTRU 602 may acquire location information by way of any suitable location-determination method while remaining consistent with an embodiment.

The processor 618 may further be coupled to other peripherals 638, which may include one or more software and/or hardware modules that provide additional features, functionality and/or wired or wireless connectivity. For example, the peripherals 638 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

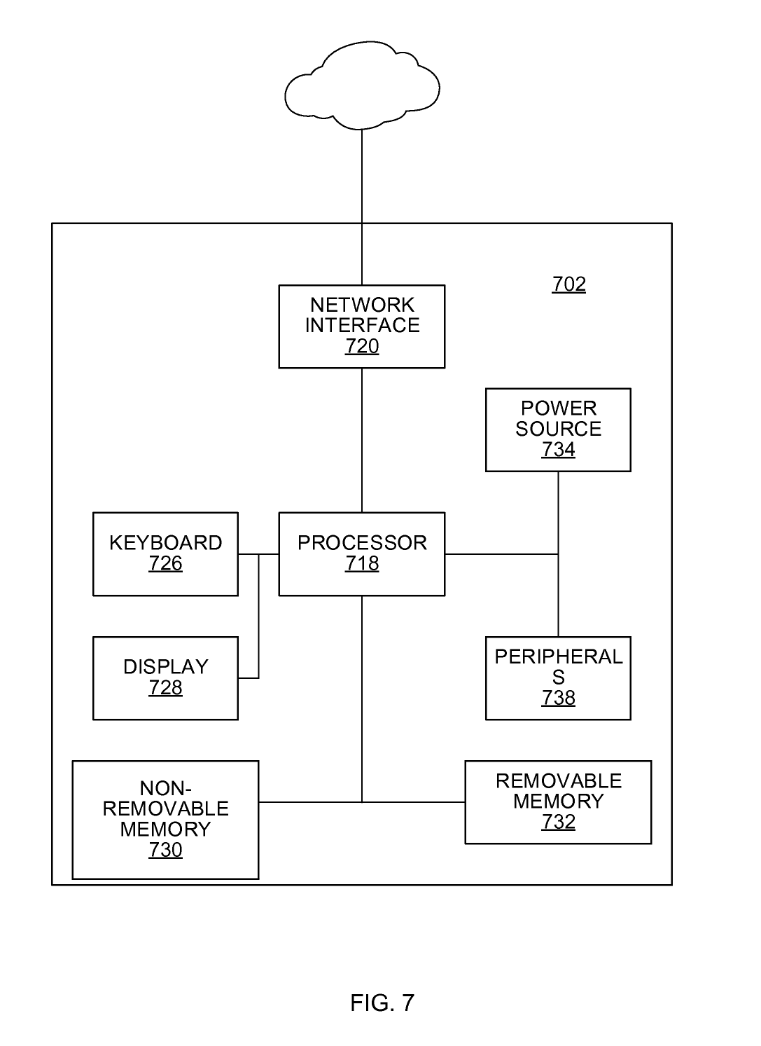

In some embodiments, the systems and methods described herein may be implemented in a networked server, such as server 702 illustrated in FIG. 7. For example, the UGC processing may be implemented using one or more software modules on a networked server.

As shown in FIG. 7, the server 702 may include a processor 718, a network interface 720, a keyboard 726, a display 728, a non-removable memory 730, a removable memory 732, a power source 734, and other peripherals 738. It will be appreciated that the server 702 may include any sub-combination of the foregoing elements while remaining consistent with an embodiment. The server may be in communication with the internet and/or with proprietary networks.

The processor 718 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 718 may perform signal coding, data processing, power control, input/output processing, and/or any other functionality that enables the server 702 to operate in a wired or wireless environment. The processor 718 may be coupled to the network interface 720. While FIG. 7 depicts the processor 718 and the network interface 720 as separate components, it will be appreciated that the processor 718 and the network interface 720 may be integrated together in an electronic package or chip.

The processor 718 of the server 702 may be coupled to, and may receive user input data from, the keypad 726, and/or the display 728 (e.g., a liquid crystal display (LCD) display unit or organic light-emitting diode (OLED) display unit). The processor 718 may also output user data to the display/touchpad 728. In addition, the processor 718 may access information from, and store data in, any type of suitable memory, such as the non-removable memory 730 and/or the removable memory 732. The non-removable memory 730 may include random-access memory (RAM), read-only memory (ROM), a hard disk, or any other type of memory storage device. In other embodiments, the processor 718 may access information from, and store data in, memory that is not physically located at the server 702, such as on a separate server (not shown).

The processor 718 may receive power from the power source 734, and may be configured to distribute and/or control the power to the other components in the server 702. The power source 734 may be any suitable device for powering the server 702, such as a power supply connectable to a power outlet.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method of operating an augmented reality device having a see-through display, the method comprising:
operating a camera of the augmented reality device to obtain an image of a printed page of text;
using image recognition to retrieve an annotation associated with the page, the annotation comprising-information identifying a region of the page to be highlighted; and
operating the augmented reality device to display the highlighting as a transparent overlay on the identified region of the page.

2. (canceled)

3. The method of claim 1, wherein using image recognition to retrieve the annotation does not include comparing text of the printed page with text of a reference page.

4. The method of claim 1, wherein using image recognition to retrieve the annotation includes performing a Hough transform on the image.

5. (canceled)

6. (canceled)

7. (canceled)

8. The method of claim 7, wherein the annotation includes text of a marginal note, and wherein displaying the annotation includes operating the augmented reality device to display the marginal note.

9. The method of claim 1, wherein using image recognition to retrieve the annotation includes:
generating a perceptual hash of the image; and
comparing the generated perceptual hash with a plurality of reference perceptual hashes.

10. The method of claim 1, wherein using image recognition to retrieve the annotation includes:
generating a signature value of the image; and
comparing the generated signature value with a plurality of reference signature values.

11. The method of claim 1, wherein using image recognition to retrieve the annotation includes sending information derived from the image to a network service and receiving the annotation from the network service.

12. The method of claim 1, further comprising:
receiving an instruction to annotate a portion of the printed page of text; and
storing the annotation.

13. The method of claim 12, wherein the instruction to annotate includes an instruction to highlight a portion of the page, and wherein storing the annotation includes storing information identifying the portion of the page to highlight.

14. The method of claim 12, wherein the instruction to annotate includes an instruction to provide a marginal note on the page, and wherein storing the annotation includes storing text of the marginal note.

15. An augmented reality annotation method comprising:
obtaining an input image of a printed page of text;
using image recognition, comparing the input image with a plurality of reference images to identify a matching reference image;
retrieving an annotation associated with the matching reference image, wherein the annotation comprises information identifying the portion of the page to highlight; and
providing the annotation to an augmented reality device.

16. The method of claim 15, further comprising operating the augmented reality device to display the annotation as an overlay on the printed page of text.

17. The method of claim 15, wherein the use of image recognition to compare the input image with a plurality of reference images includes:
generating a perceptual hash of the input image; and
comparing the generated perceptual hash with a plurality of reference perceptual hashes associated with the reference images.

18. The method of claim 15, further comprising:
receiving an instruction to annotate a portion of the printed page of text; and
storing the annotation.

19. The method of claim 18, wherein the instruction to annotate includes an instruction to highlight a portion of the page, and wherein storing the annotation includes storing information identifying the portion of the page to highlight.

20. An augmented reality device having a camera, a see-through display, a processor, and non-transitory computer-readable storage medium, the storage medium storing instructions that are operative, when executed on the processor:
to obtain an image of a printed page of text from the camera;
to use image recognition to retrieve an annotation associated with the identified page the annotation comprising information identifying a region of the page to be highlighted; and
to display the highlighting as a transparent overlay on the identified region of the printed page of text using the see-through display.
